(19) United States
(12) Patent Application Publication
(10) Pub. No.: US 2014/0034246 A1
(43) Pub. Date: Feb. 6, 2014

(54) METHODS AND SYSTEM FOR PRODUCING ON-DEMAND REDUCTION IN COUPLING STRENGTH OF PRESSURE-SENSITIVE ADHESIVES

(71) Applicants: George B. Kenney, Medfield, MA (US); Christian Pfeffer, Somerville, MA (US)

(72) Inventors: George B. Kenney, Medfield, MA (US); Christian Pfeffer, Somerville, MA (US)

(73) Assignee: Siband LLC, Medfield, MA (US)

(21) Appl. No.: 13/979,486

(22) PCT Filed: Jan. 12, 2012
(86) PCT No.: PCT/US12/21148

§ 371 Date: Oct. 21, 2013

Related U.S. Application Data
(60) Provisional application No. 61/432,169, filed on Jan. 12, 2011.
(60) Provisional application No. 61/435,394, filed on Jan. 24, 2011.
(60) Provisional application No. 61/445,987, filed on Feb. 23, 2011.

(51) Int. Cl. B32B 43/00; C09J 7/02

(52) U.S. Cl. CPC B32B 43/006; C09J 7/0207
USPC 156/705; 428/343; 428/192; 156/754

(57) ABSTRACT

The systems and methods of the present disclosure relate to safely coupling and decoupling various solid objects with the use of pressure-sensitive adhesive. In particular, the disclosure relates to methods and systems for delivering vibrational energy to a pressure-sensitive coupled structure, sufficient to decrease coupling strength of the pressure-sensitive adhesive as well as to de couple or reposition the coupled objects.

### BACKGROUND OF THE INVENTION

1. The Field of the Invention

This invention relates to systems and methods for reducing bonding or coupling strength of pressure-sensitive adhesives.

2. Background and Relevant Art

A pressure-sensitive adhesive (PSA) is an adhesive that can form a bond with an object when pressure is applied to the PSA and/or the object. When used between two objects, the PSA can bond or couple the objects one to the other. For example, two objects separated by a PSA can be pressed together to couple one to the other. Ordinarily, the degree (or strength) of such coupling depends on the amount of pressure applied. Further description of PSAs can be found in “Pressure-Sensitive Adhesives and Applications,” Second Edition (2004), Istvan Benedek, Marcel Dekker Inc., and “Adhesives and Adhesive Tapes”, G. Gierenz, W. Karmann, Wiley-VCH, the entire content of which is incorporated by reference herein.

Furthermore, PSAs can have a wide range of coupling strengths, which can make PSAs useful for numerous applications. In some instances, PSAs can be used to couple two objects together to form an essentially permanent coupling between them. Hence, the objects coupled through (or by) the PSA usually cannot be decoupled without damaging or breaking one or both of the objects. For example, a safety or a shipping label that has PSA can couple to an object such that the label usually cannot be removed without damage.

Alternatively, PSAs also can removably couple two or more objects. Such PSAs typically exhibit lower coupling strength, which allows coupling and decoupling of the objects. For example, typical masking tapes, surface protections films, or sticky notes can be attached to an object and subsequently removed therefrom, without damage Importantly, however, to allow for such removable coupling, a PSA typically has a reduced coupling strength, such that would permit removal without damage. Accordingly, a user or manufacturer ordinarily has to compromise coupling strength of the PSA to facilitate decoupling of the coupled objects without damage.

In some instances, reduction of a PSA's coupling strength beyond a certain point can render the PSA (and the object to which the PSA is attached) unsatisfactory. For example, it is desirable for a typical bandage to remain attached to a patient's skin for a desired duration of treatment. Thus, it is desirable that a PSA that couples such a bandage to the skin has sufficient coupling strength to permit such usability. Unfortunately, however, increasing the coupling strength of the PSA to make the PSA strong enough to remain coupled for longer periods of treatment, oftentimes can result in damage to one or more of the bandage, the PSA, or the patient upon removing the bandage.

In the above example, a bandage that strongly couples to the patient's skin can tear or damage the skin in some applications. Moreover, decoupling of a bandage strongly coupled to the patient's skin can be painful and disruptive to the healing process of a wound covered by such bandage. Similarly, various other applications that require a PSA that has increased coupling strength can result in damaging or breaking one or both of the coupled objects during decoupling. In such instances, and where preservation of one or both of the coupled objects is needed, the conventional decoupling of PSAs may be unsatisfactory.

Accordingly, there are a number of disadvantages in decoupling of pressure-sensitive adhesives that can be addressed.

### BRIEF SUMMARY OF THE INVENTION

Implementations of the present invention provide systems and methods for reducing coupling strength of pressure-sensitive adhesives (PSAs). For instance, such systems and methods can produce sufficient reduction of the coupling strength to allow repositioning of one or more objects coupled by the PSA. Such implementations also can allow coupling of a plurality of objects and subsequent decoupling of the objects without breakage or damage thereto. Accordingly, one or more implementations can allow two or more objects to be coupled through the PSA, such that the objects remain substantially immobilized with respect to each other. When desired, however, the strength of the PSA can be selectively reduced to allow the objects to be repositioned with respect to each other or decoupled without damage.

One or more implementations include a method of repositioning a first object relative to a second object. The first object is coupled to the second object by a pressure-sensitive adhesive (PSA). A first force is required to move the first object relative to the second object. The method includes decreasing a coupling strength of the PSA by applying an amount of vibrational energy to one or more of the first object, the second object, and the PSA. The coupling strength of the PSA is reduced so that a second force is required move the first object relative to the second object. Furthermore, the second force is less than the first force. The method also includes repositioning the first object relative to the second object by applying the second force.

At least one implementation can include a method of decoupling a first object from a second object, the first object being coupled to the second object by a pressure-sensitive adhesive (PSA) and requiring a first force to be decoupled. The method includes decreasing a coupling strength of the PSA by delivering an amount of vibrational energy to one or more of the first object, the second object, and the PSA. The coupling strength of the PSA is reduced to require a second force to decouple the first and second objects. The second force is less than the first force. The method also includes at least partially decoupling the first and second objects by applying the second force.

Yet another implementation includes a method of decoupling a first object from a second object, the first object being coupled to the second object by a pressure-sensitive adhesive (PSA), which requires a first force to be decoupled. The method includes using a vibration device to reduce a coupling strength of the PSA by delivering an amount of vibrational energy to one or more of the first object, the second object, and the PSA. The coupling strength of the PSA is reduced to require a second force to decouple the first object and the second object. The second force is less than the first force. The method also includes applying the second force to at least partially decouple the first and second objects.

Additionally, in one or more implementations, a bonding strip configured to be coupled to an object includes a sheet material and a pressure-sensitive adhesive disposed on a first side of the sheet material. The bonding strip also has one or more tabs secured proximate to an edge or extending from the edge of the sheet. Moreover, the one or more tabs are configured to remain uncoupled from or lightly coupled to the object or the bonding strip.

In at least one implementation, a vibration device for delivering vibrational energy to a PSA-coupled structure includes a body containing a vibratory mechanism. The vibration device also includes a tip coupled to the body. The vibratory mechanism is configured to produce vibrations in the tip in the range of 20 Hz to 20,000 Hz. The tip has a substantially spherical shape.

In yet another implementation, a system for removably coupling a plurality of objects includes a first object having a first side and a second side. The system further includes a pressure-sensitive adhesive having a coupled side and an uncoupled side. The coupled side of the pressure-sensitive adhesive is coupled to the first side of the first object. The uncoupled side of the pressure-sensitive adhesive is configured to couple to a second object. The system also includes a vibration device configured to deliver vibrational energy to one or more of the first object, the second object, and pressure-sensitive adhesive sufficient to reach one or more of an interface between the pressure-sensitive adhesive and the first object or the second object and the pressure-sensitive adhesive, thereby reducing coupling strength of the pressure-sensitive adhesive.

Furthermore, at least one implementation includes a pressure-sensitive adhesive coupled structure configured to have an improved response to delivery and transfer of vibrational energy to reduce coupling strength. Such implementations include a first object having a first side and a second side and a second object having a first side and a second side. Additionally, such implementations include a pressure-sensitive adhesive coupled to the first side of the first object and to the first side of the second object, and a plurality of embedded elements within the pressure-sensitive adhesive.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. It should be noted that the figures are not drawn to scale, and that elements of similar structure or function are generally represented by like reference numerals for illustrative purposes throughout the figures. Understanding that these drawings depict only typical embodiments of the invention and are not therefore to be considered to be limiting of its scope, the invention will be described and explained with additional specificity and detail through the use of the accompanying drawings in which:

FIG. 1 illustrates a perspective view of a pressure-sensitive adhesive coupled structure in accordance with one implementation of the present invention;

FIG. 2 illustrates a perspective view of a pressure-sensitive adhesive coupled structure of FIG. 1 with a partially decoupled object;

FIG. 3 illustrates a perspective view of the pressure-sensitive adhesive coupled structure of FIG. 1 with the objects respectively repositioned;

FIG. 4 illustrates a perspective view of a pressure-sensitive adhesive coupled structure with a partially decoupled object and a vibration device in contact with one object in accordance with one implementation of the present invention;

FIG. 5 illustrates a perspective view of a pressure-sensitive adhesive coupled structure with a partially decoupled object and a vibration device proximate to a peel interface in accordance with one implementation of the present invention;

FIG. 6 illustrates a perspective view of a bristled tip of the vibration device in accordance with one implementation of the present invention;

FIG. 7 illustrates a perspective view of a ribbed tip of a vibration device in accordance with one implementation of the present invention;

FIG. 8 illustrates a perspective view of a multi-structure tip of a vibration device in accordance with one implementation of the present invention;

FIG. 9 illustrates a perspective view of an object with a tab in accordance with one implementation of the present invention;

FIG. 10 illustrates a perspective view of a pressure-sensitive adhesive coupled structure that has pressure-sensitive adhesive with embedded particles in accordance with one implementation of the present invention;

FIG. 11 illustrates a perspective view of a pressure-sensitive adhesive coupled structure that has pressure-sensitive adhesive with embedded fibers in accordance with one implementation of the present invention;

FIG. 12 illustrates a perspective view of a pressure-sensitive adhesive coupled structure that has pressure-sensitive adhesive with embedded cylindrical rods in accordance with one implementation of the present invention;

FIG. 13 illustrates a perspective view of a pressure-sensitive adhesive coupled structure that has pressure-sensitive adhesive with embedded lamella in accordance with one implementation of the present invention;

FIG. 14 illustrates a chart of acts and steps in a method of decreasing a coupling strength of a pressure-sensitive adhesive by applying vibrational energy in accordance with an implementation of the present invention;

FIG. 15 illustrates graphs that show pull force reduction obtained during experiments in accordance with one implementation of the present invention; and

FIG. 16 illustrates graphs that show pull force reduction that was obtained in other experiments.

### DETAILED DESCRIPTION OF THE PREFERRED EMBODIMENTS

Implementations of the present invention provide systems and methods for reducing coupling strength of pressure-sensitive adhesives (PSAs). For instance, such systems and methods can produce sufficient reduction of the coupling strength to allow repositioning of one or more objects coupled by the PSA. Such implementations also can allow coupling of a plurality of objects and subsequent decoupling of the objects without breakage or damage thereto. Accordingly, one or more implementations can allow two or more objects to be coupled through the PSA, such that the objects remain substantially immobilized with respect to each other. When desired, however, the strength of the PSA can be selectively reduced to allow the objects to be repositioned with respect to each other or decoupled without damage.

Generally, vibrational energy can be delivered to one or more objects that are coupled by the PSA as well as to the PSA, such that the vibrational energy travels to the PSA and/or an interface between the PSA and one or more objects. The quantity of the vibrational energy can depend on the reduction in coupling strength of the PSA that is desired. For instance, more vibrational energy delivered to one or more of the objects coupled by the PSA can result in greater reduction of the coupling strength of the PSA. In particular, increasing the amount of vibrational energy delivered to one or more of objects and the PSA, can increase the amount of vibrational energy present within the PSA as well as at the interface between one or more of the objects and the PSA. Such increase of the vibrational energy present at the interface of and within the PSA can reduce the coupling strength of the PSA.

Accordingly, delivering vibrational energy can facilitate decoupling of objects coupled by the PSA to reduce or eliminate damage to the objects during decoupling. Moreover, ability to reduce coupling strength of the PSA can facilitate stronger coupling of objects using PSA, when such objects would have to be decoupled or repositioned at a later time. Description herein, at least in part, relates to delivering the vibrational energy to one or more of the objects and to the PSA. It should be noted, however, that effectiveness of the delivered vibrational energy to one or more of the objects and the PSA, as it relates to decreasing the coupling strength of the PSA, can depend, in part, on the amount of vibrational energy that can reach the PSA and/or the interface between the PSA and one or more objects. Hence, increased penetration rate of the vibrational energy through one or more objects and the PSA can respectively increase the amount of vibrational energy delivered to the PSA and/or to the interface between the PSA and one or more objects, which can result in decreased coupling strength of the PSA to one or more objects.

For instance, as illustrated in FIG. 1, a PSA-coupled structure 100 can include a first object 110, a second object 120, and a PSA 130, which can be in a form of a layer between the first and second objects 110, 120. The first object 110 and/or second object 120 can be essentially any solid material. Pressure can be applied to couple the first and/or second objects 110, 120 to and through the PSA 130. In one or more implementations, the coupling strength of the PSA can depend, in part, on the amount of pressure applied at an interface between the PSA 130 and the first and/or second objects 110, 120.

The coupling strength of the PSA also can depend on surface roughness, surface energy, surface contaminants, and other factors. In some instances, the PSA 130 can have substantially the same coupling strength with the first object 110 as with the second object 120. Additionally, internal strength of the PSA 130 can be lower than the coupling strength of the PSA 130 at an interface with the first object 110 and second object 120. Accordingly, during decoupling, a portion of the PSA 130 can remain coupled to the first object 110 and another portion of the PSA 130 can remain coupled to the second object 120.

Alternatively, the PSA 130 can have a greater coupling strength with the first object 110 than with the second object 120, and the reverse. Consequently, during decoupling of the first object 110 and the second object 120, substantially all of the PSA 130 can remain on predetermined object (either on first object 110 or on second object 120), whichever has the strongest coupling to the PSA 130. Thus, a manufacturer can design the first object 110, second object 120, and/or PSA 130, such that the PSA 130 remains in a desired position. For example, the first object 110 can be an adhesive bandage that can couple to a patient's skin (the second object 120) can have a stronger coupling with the PSA 130 than the patient's skin; hence, the PSA 130 can remain on the adhesive bandage after the adhesive bandage is decoupled from the skin.

Additionally, the first and second objects 110, 120 can have various shapes and thicknesses. For example, the first and/or second objects 110, 120 can have a substantially spherical, cubic, or other regular or irregular shape. Similarly, the first and/or second objects 110, 120 can have a sheet-like shape, such that a thickness of the first and/or second objects 110, 120 is substantially less than width or length thereof.

In at least one implementation, the PSA 130 can form a uniform or nonuniform layer that contacts, at least in part, the first object 110 and second object 120. Such layer can have a thickness of approximately 100 μm. Alternatively, thickness of such layer can be greater or less than 100 μm. For instance, the thickness of the PSA 130 can be between 1 nm and 100 mm The PSA 130 also can be in a non-layer form, such that the PSA 130 can couple the first object 110 and second object 120. For example, the PSA 130 can be deposited on or coupled to the first object 110 in isolated spots, such that would contact the second object 120 and couple the first object 110 to the second object 120.

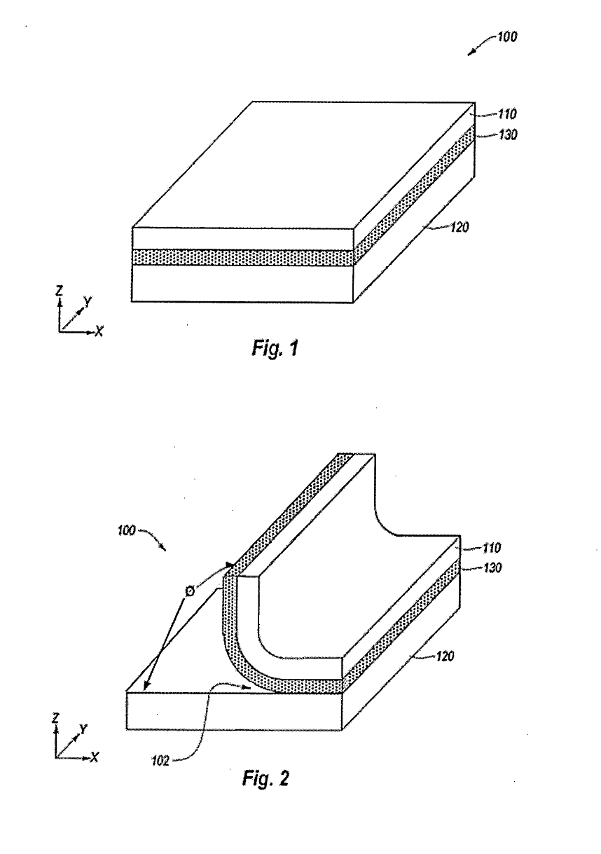

To decouple the first object 110 and second object 120, the first object 110 can be lifted or pulled away from the second object 120. As illustrated in FIG. 2, direction of such pull (i.e., pull direction) can form a pull angle θ with respect to a plane tangent to an interface between the first object 110, second object 120, and PSA 130. For instance, the first object 110 can be pulled in the direction substantially perpendicular to a plane defined by x-axis and y-axis (i.e., θ≈90°). Alternatively, the pull angle θ can be greater or less than 90°. In some instances, the force required to decouple the first object 110 from the second object 120 also can vary with pull angle.

When a portion of the first object 110 and second object 120 decouple one from another, the resulting joint can include a peel interface 102. As the first object 110 and second object 120 further decouple, the peel interface 102 can shift, such that the new position of the peel interface 102 is proximate to decoupled portions of the first object 110 and second object 120 as well as to the coupled portions thereof. The shape and area of the peel interface 102 can depend on the particular shapes of the first object 110 and second object 120.

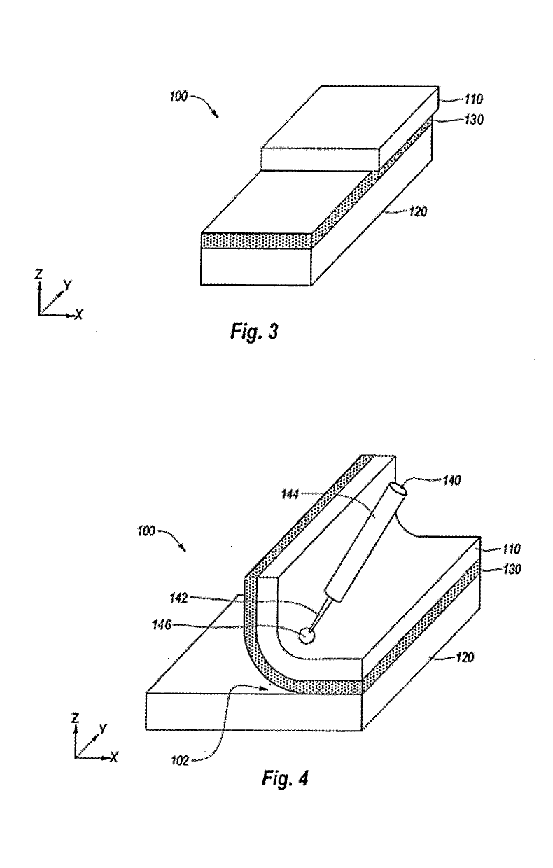

The peel interface also can form when the first object 110 and second object 120 slide with respect to one another, as illustrated in FIG. 3. Such sliding can be in response to a force applied in a lateral direction (i.e., tangent to the interface between the first object 110 and second object 120) to the first object 110 and/or second object 120. For example, the first object 110 can be pulled along the y-axis, such as that the first object 110 changes position with respect to the second object 120. Alternatively, such sliding can be rotational in nature and can occur in response to rotational force (torque) applied to the first object 110 and/or second object 120.

When a user attempts to reposition, decouple, or slide the first object 110 or the second object 120, the PSA 130 can resist such decoupling or repositioning. As used herein, the term “reposition,” as it relates to “repositioning” of the first object 110 with respect to the second object 120, refers to decoupling, sliding, moving, or otherwise changing position of the first object 110 and second object 120 with respect to one another, in any manner. The amount of force required to decouple and/or reposition the objects coupled by the PSA 130 can depend at least in part on the coupling strength of the PSA 130.

The PSA 130 can have various compositions, which can have various coupling strengths. Furthermore, the coupling strength of the PSA 130 can vary based on the properties of the object the PSA 130 couples to. In at least one implementation, the coupling strength of the PSA 130 can be such that without decreasing such coupling strength of the PSA 130 by external means the first object 110 and the second object 120 cannot be decoupled or repositioned with respect to each other without damaging or breaking the first and/or second objects 110, 120.

In one or more implementations, vibrational energy can be delivered to the first object 110, second object 120, and/or the PSA 130 to decrease the coupling strength of the PSA 130 therewith. As used herein, the terms delivered or delivery of “vibrational energy” refer to the quantum of energy as measured at the source and not at the first object 110 or second object 120 (e.g., the frequency and amplitude of vibration of the vibration device used for delivering vibration). As discussed above, the amount (or percent) of reduction in the coupling strength of the PSA 130 can depend on the quantity of vibrational energy delivered to the first object 110, second object 120, and/or PSA 130. Thus, as further described below, sufficient amount of vibrational energy can be delivered to the first object 110 and/or second object 120, such that reduction in the coupling strength of the PSA 130 can result in a corresponding reduction in the force required to decouple and/or respectively reposition (i.e., the pull force) the first object 110 and second object 120. Accordingly, such vibrational energy, when delivered to the PSA-coupled structure 100, can reduce the amount of force required to decouple, slide, and/or respectively reposition the first object 110 and second object 120.

In one or more implementations, vibrational energy applied to the reduce the coupling strength of the PSA 130 can include vibrations in the range of 1 Hz to 20,000 Hz (i.e., the sonic range). Such vibrations can sufficiently reduce the coupling strength of the PSA 130, such that to reduce the pull force required to decouple the first object 110 and second object 120. In at least one implementation, vibrational energy applied to the reduce the coupling strength of the PSA 130 also can include vibrations in excess of 20,000 Hz (i.e., ultrasonic range). Moreover, vibrational energy applied to the reduce the coupling strength of the PSA 130 can vary during the delivery. For instance, the vibrational energy applied to the reduce the coupling strength of the PSA 130 can fluctuate between 50 Hz and 500 Hz. Additionally or alternatively, the frequency of the vibrations can fluctuate in other ranges.

Also, the amplitude of the vibrational energy can range from the nanometer to the millimeter range. For instance, the amplitude of the vibrational energy can range from 10 nm to 10 mm In light of this disclosure, those skilled in the art should appreciate that desired amplitude and frequency can be selected or obtained based, in part, on the material and shape of the first object 110 and second object 120 as well as on the type of the PSA 130 used in the PSA-coupled structure 100. Similarly, the appropriate amount of power, such that would transfer the vibrational energy into the PSA coupled structure 100 without undesirable amount of dampening, can be selected or obtained.

In at least one implementation, a vibration device can deliver the vibrational energy to the PSA-coupled structure 100. For example, as illustrated in FIG. 4, at least a portion of a vibration device 140 can contact the first object 110, second object 120, and/or PSA 130, thereby delivering the vibrational energy to the first object 110, second object 120, and/or PSA 130. The vibration device 140 can include an electromagnetic drive assembly, a piezoelectric drive assembly, an acoustic horn assembly, an ultrasonic drive circuit, a sonic drive circuit, and/or other comparable devices, which can generate vibration at desired frequencies of at least a portion of the vibration device 140. In some instances, the vibration device 140 also can incorporate a vibrating head 142, which can deliver vibrational energy to the PSA-coupled structure 100.

The vibration device 140 also can include a body 144, which can be held by the user. The vibrating head 142 can isolate the vibrations from the body 144, such that the user does not experience any or a reduced amount of vibration during the use of the vibration device 140. The vibrating head 142 can be integrated with the body 144, such that the vibration device 140 comprises a single unit. Alternatively, the vibrating head 142 can be removably coupled to the body 144.

The vibration device 140 also can be light-weight, portable, and/or powered by a portable power source or by a wire to electrical service or a generator. A portable vibration device 140 can be used for medical applications (for example removing bandages or ostomy appliances), household applications (removing packaging tapes or wallpaper) or light industrial applications (removing signs from buses or duct tape from ducts). In industrial settings a non-portable vibration device 140 can be used.

In one or more implementations, the vibrating head 142 can be removed and replaced. For instance, the vibrating head 142 can be disposable, such that after a desired number of uses, the vibrating head 142 can be removed and discarded. Such configuration can be particularly beneficial for applications in which the vibrating head 142 can be contaminated, damaged, or broken during use. For example, the first and second objects 110, 120 can be a medical bandage and patient's skin, respectively, and the vibration device 140 can be used in to deliver vibrational energy to the medical bandage (i.e., the first object 110), in order to reduce the coupling strength of the bandage, such that the bandage can be painlessly and/or safely removed from the patient's skin. As such, discarding the vibrating head 142 may be advantageous, in order to avoid cross-contamination of wounds.

Additionally or alternatively, the vibration device 140 can include a cover, which can fit over a portion of the vibration device 140; for example, a portion that comes into contact with an area that may cause contamination of the vibration device 140. Such cover also can be disposable and can be discarded after a desired number of uses. In light of this disclosure, those skilled in the art should appreciate other configurations for the vibration device 140 that would allow to discard and/or remove and replace a portion of the vibration device 140 that was contaminated, damaged, or broken during use.

As discussed above, the vibration device 140 can deliver vibrational energy to the PSA-coupled structure 100. In particular, a portion of the vibration device 140, such as a tip 146, can contact the first object 110, second object 120, and/or PSA 130 to deliver the vibrational energy. In one or more implementations, the tip 146 of the vibration device 140 can contact the first object 110 and/or second object 120, while the first and second objects 110, 120 are completely coupled to the PSA 130 and through the PSA 130 to one another. Additionally, when at least a portion the first object 110 is decoupled from the second object 120 (and vice versa), the vibration device 140 can contact the decoupled portions of the first object 110 and/or second object 120 as well as the coupled portions of the first and/or second objects 110, 120, to deliver the vibrational energy. Moreover, the vibration device 140 can contact the first object 110 or second object 120 proximate to the peel interface 102, such as the contact point is separated from the peel interface 102 by a thickness of the first object 110 or second object 120.

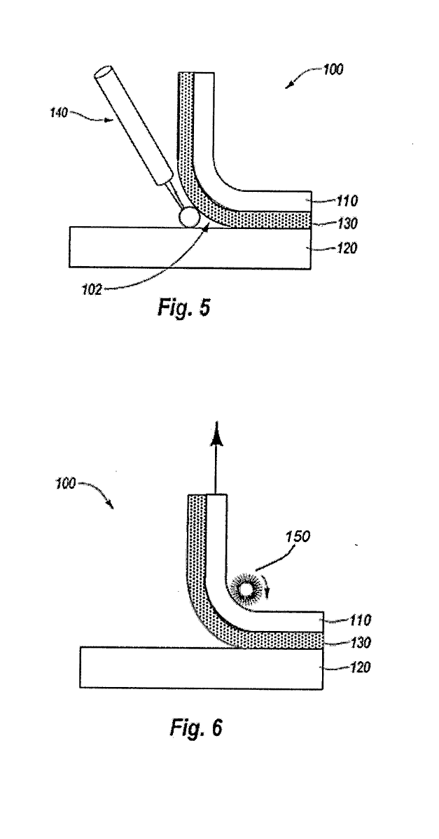

Furthermore, as illustrated in FIG. 5, in some instances, the vibration device 140 also can contact the PSA 130. For example, when the first and second objects are partially decoupled, the vibration device 140 can contact the first object 110, second object 120, and/or PSA 130. It should be noted that, as described above, the PSA 130 can remain on the first object 110, the second object 120, and partially on both the first and the second objects 110, 120, after the first object 110 and the second object 120 decouple.

In at least one implementation, the vibration device 140 can deliver the vibrational energy sufficient to reduce coupling strength of PSA 130 that couples the first and second objects 110, 120. Accordingly, the vibration device 140 can be used to remove or aid in removal of the PSA 130 from the first object 110, second object 120, or both. For instance, the vibration device 140 can contact the PSA 130 and deliver the vibrational energy sufficient to reduce the coupling strength of the PSA 130 and the first object 110 and/or the second object 120. Moreover, the vibration device 140 can apply force to the PSA 130 such as to lift the PSA 130 off the first object 110 or the second object 120.

In one or more implementations, the vibrational energy can be delivered in one or more than one direction within and through the PSA-coupled structure 100 (i.e., the direction of travel of vibrational wave). For instance, the vibrational energy can be delivered in a direction that is substantially parallel to the pull direction. Alternatively, the vibrational energy can be delivered in a direction substantially orthogonal to the pull direction. In one or more implementations, the vibrational energy also can be delivered in other directions. Moreover, the direction of vibrational energy can change (e.g., during the decoupling or repositioning). Such change can occur as a result of the user's action or can be performed by the vibration device 140.

A portion of the vibration device 140, such as the tip 146, can rotate, such that direction of the vibrational energy delivered into the PSA-coupled structure 100 can change with the rotation of the tip 146. Additionally or alternatively, a portion of the vibration device 140 also can move in various directions (e.g., along a width of the first object 110 or along the peel interface 102).

The vibrating head 142 also can include a tip 146. For instance, tip 146 can contact the first object 110, second object 120, and/or PSA 130 to deliver the vibrational energy into the system 100. Accordingly, the shape, material, and movement patterns of the tip 146 can determine at least in part how and in what form the vibrational energy is delivered to the PSA-coupled structure 100.

For example, the tip 146 can have at least one dimension that is greater than another dimension, such that to form an elongate shape. Such shape can permit the vibration device 140 to have greater maneuverability and/or versatility, by allowing the user to contact the PSA-coupled structure 100 in narrow places. Moreover, size of the tip 146 can be such as to cover an entire surface area of the first object 110 and/or second object 120. The size of the tip 146 also can be such as to span an entire length or width of the first object 110 and/or second object 120. Alternatively, the tip 146 can have a size such as to span only a portion of the width or length of the first object 110 and/or second object 120.

Furthermore, as described above, the tip 146 can have various shapes, which can improve delivery of the vibrational energy. In particular, the shape of the tip 146 can be such as to minimize dampening effect of contact with the first object 110, second object 120, and/or PSA 130, which can reduce the amplitude and frequency of the vibration at the tip 146 of the vibration device 140. Generally, the tip 146 can have sufficiently high friction with or gripping of the first object 110 or second object 120 to achieve a desired delivery of the vibrational energy. For instance, it may be desirable for the tip 146 to intermittently grip the first object 110, second object 120, and/or PSA 130, such that to improve the delivery of vibrational energy.

In one or more implementations, the tip 146 can include bristles 150, as illustrated in FIG. 6. Such bristles 150 can have various stiffness, dimensions, and positions. Furthermore, such bristles 150 can be secured to a substantially spherical, hemispherical, prismoid, or irregular shape, as best suited for a particular application. By increasing the stiffness of the bristles 150, the amount of vibrational energy delivered into the PSA-coupled structure 100 also can increase (assuming the same pressure on the tip 146). The user can balance such increase in the delivered vibrational energy with the potential damage that stiffer bristles 150 can cause the first object 110 and/or second object 120. In light of this disclosure, those skilled in the art should appreciate that bristles 150 can be made from various materials, such as plastics or metals.

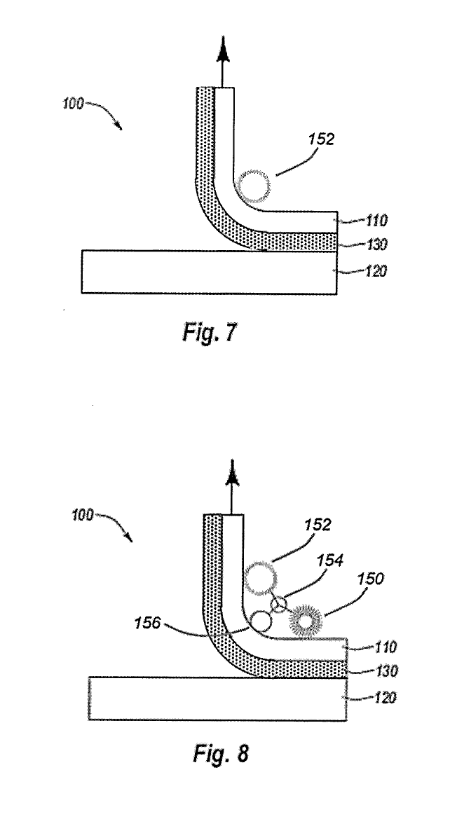

Additionally or alternatively, the tip 146 can include multiple ribs 152, as illustrated in FIG. 7. Such ribs 152 can contact the first object 110, second object 120, and/or PSA 130 to deliver the vibrational energy. The ribs 152 can have various stiffness, shapes, and positions on the tip 146. In one or more implementations, the ribs 152 can have pyramid-like shapes. Accordingly, ribs 152 can latch onto or grab the first object 110, second object 120, and/or PSA 130, such that to deliver the vibrational energy.

As illustrated in FIG. 8, one or more implementations also can include a multiple-structure tip 146. For instance, the tip 146 can include a portion that comprises bristles 150 and a portion that comprises ribs 152. Multiple portions of the tip 146 can be interconnected at a vibratory core 154. The vibratory core 154 also can include and interconnect a smooth portion 156.

In one or more implementations, the smooth portion 156 can include a thin layer of adhesive, such as PSA, which can lightly couple or bond the smooth portion of the tip 146 to the first object 110 and/or second object 120. Such light coupling can improve delivery of the vibrational energy into the PSA-coupled structure 100. Furthermore, such light coupling can improve usability of the vibration device 140 by helping the user to maintain contact with the first object 110 and/or second object 120 during decoupling.

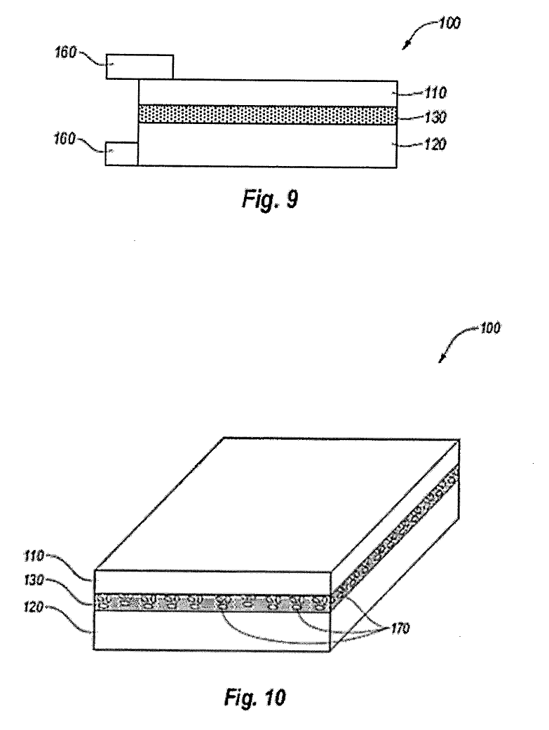

As illustrated in FIG. 9, in at least one implementation, the first object 110 and/or second object 120 can include a tab 160. For instance, a portion of the first object 110 and/or second object 120 also can integrate the tab 160. A secured tab 160 also can be integrated with the first object 110 and/or second object 120. Alternatively, the tab 160 can be permanently or removably secured to the first object 110 and/or second object 120.

The tab 160 can be positioned (i.e., secured) on any portion of the first object 110 and/or second object 120. When desirable, the tab 160 can be secured proximate to an edge of the first object 110 and/or second object 120. Additionally or alternatively, the tab 160 can protrude or extend from an edge of the first object 110 and/or second object 120. Furthermore, the tab 160 can remain uncoupled or lightly coupled to either first object 110 and/or second object 120 (i.e., the tab 160 can have PSA such that can lightly couple the tab to an object).

Accordingly, such tab 160, for example, can allow the user to hold onto a portion of the first object 110 that would be otherwise coupled to the second object 120 (through the PSA 130). The tab 160 can have a length in the range of 1 mm to 100 mm Additionally, the tab 160 can have other lengths as would be practicable for a particular application. Similarly, the tab 160 can have various widths. For instance, the tab 160 can have a width that is equal to, less than, or greater than the width of the first object 110 and/or second object 120 (as applicable).

As described above, the vibration device 140 can deliver vibrational energy to the PSA-coupled structure 100, such as to reduce the amount of force required to decouple and/or respectively reposition the first object 110 and second object 120. The tab 160 can allow the user to deliver the vibrational energy to the PSA-coupled structure 100 while applying a pull force onto the tab 160, such as to commence decoupling of the first object 110 and second object 120.

When the first object 110 and/or second object 120 comprise sheets or strips (i.e., sheet segments), availability of the tab 160 can be useful to commencing decoupling without damaging the first object 110 and/or second object 120. In particular, the tab 160 can facilitate initiation of decoupling by decreasing the coupling strength of the PSA 130 before applying a pull force to the first object 110 and/or second object 120.

Thus, the tab 160 can be secured, coupled to or integrated with an object that has a substantially sheet- or strip-like form, such as a bonding strip, for example a bandage or medical tape. Furthermore, such sheet also can include a medical dressing, which can cover a wound of a patient. The sheet also can include antimicrobial or microbiocidal agents and/or (e.g., zinc oxide), can be porous, such as to allow moisture, air, and/or lipids to penetrate, and can be sterile.

In one or more implementations, the first object 110 and/or second object 120 can incorporate various elements, which can increase the stiffness or rigidity of the first object 110 and second object 120. As used herein, the term “element” refers to particles of micron and sub-micron size (e.g., size of nanoparticles and greater) and excludes primary chemical elements and single molecules. Such incorporations can be particularly beneficial in flexible materials, such as sheets. For example, various elements can be incorporated into sheets (i.e., first object 110 and/or second object 120), such as bandages and tapes.

Incorporated elements can be variously shaped and sized particles, fibers, and rods can be incorporated. As used herein, the term “rod” refers to an element that has substantially uniform width along various directions of its cross-section (e.g., cylinder, rectangular prismoid, tube, etc.). Additionally or alternatively, the elements can comprise various materials that can enhance the delivery of the vibrational energy into the PSA coupled structure 100. For instance, various material that can stiffen the first object 110 and/or second object 120 and can, thereby, increase transmission of the vibrational energy therethrough.

Furthermore, the elements can have random arrangement or can be arranged in a desired pattern. For instance, elements can be arranged in rows or in cross-hatch patterns. Such rows or cross-hatch patterns can have various orientations in a three-dimensional space of the first object 110 and second object 120. The orientations of the rows or cross-hatch patterns also can be in a single layer (whether in a plane parallel to the object's interface with the PSA or in a plane intersecting such interface) or in multiple layers. Furthermore, orientation of the rows and/or cross-hatch patterns of elements can have various relationships with respect to the direction of the pull force applied to the first object 110 and/or second object 120. For example, elements can be rows of fibers disposed substantially along the length of the first object 110 and/or second object 120.

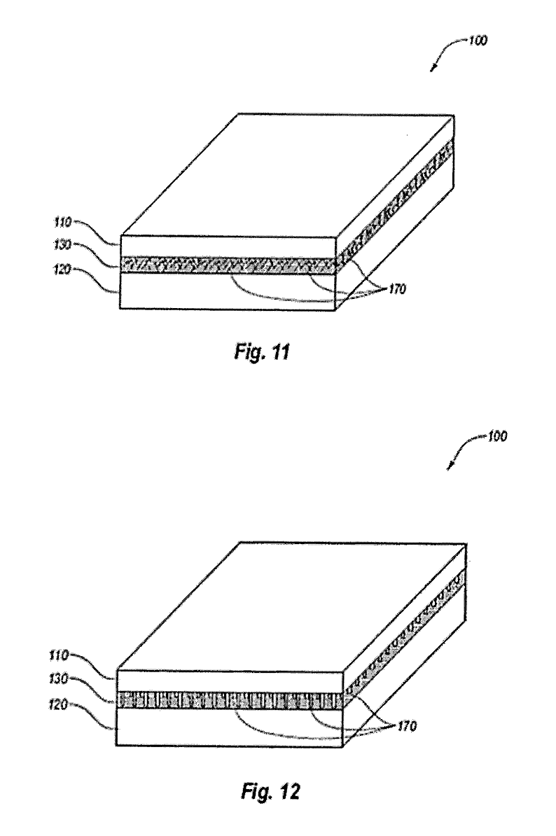

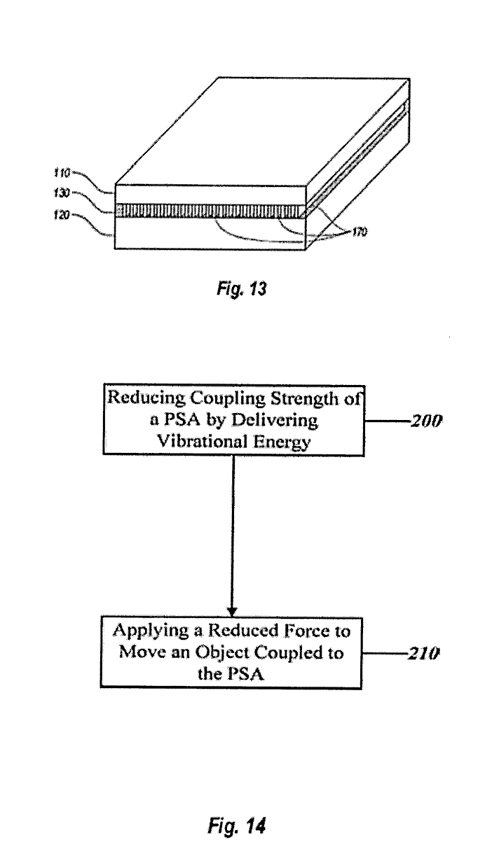

In at least one implementation, as illustrated in FIGS. 10-13, various transmission elements 170 also can be incorporated into the PSA 130, such as to facilitate improved vibrational energy delivery thereto and/or vibrational transmission therethrough, and to the interface between the object and PSA. The transmission elements 170 also can have various shapes, sizes, materials, and properties. For instance, the transmission elements 170 can be various particles, as illustrated in FIG. 10. Additionally or alternatively, the transmission elements 170 can be fiber of various sizes and orientations, including uniform or ordered and nonuniform orientations, within the PSA 130, as illustrated in FIG. 11. Furthermore, the transmission elements 170 can be rods (FIG. 12) or lamella (FIG. 13). In at least one implementation, the lamella-shaped transmission elements 170 can be a block copolymer.

In light of this disclosure, those skilled in the art should appreciate that other shapes and structures of transmission elements 170 can be used. For example, the transmission elements 170 can form a grid, a mesh, or similar structure within the PSA 130. Additionally, the transmission elements 170 can have various sizes, which can depend, in part, on the thickness of the PSA 130. Hence, the transmission elements 170 can have sizes in the range of 1 nm to 500 μm.

Such transmission elements 170 also can be substantially more rigid than the PSA 130. Additionally or alternatively, the transmission elements 170 can be resonators, such that to resonate at a particular frequency. Accordingly, the manufacturer can incorporate such various resonating elements into the PSA 130 based on the resonating frequency and the frequency that most effectively reduces the coupling strength of the PSA 130. In particular, the manufacturer can incorporate resonating transmission elements 170 that can deliver desired frequency to the interface between the PSA 130 and the first object 110 or second object 120. Similarly, resonating transmission elements 170 can amplify effects of the vibrational energy within the PSA 130, by resonating at a desired frequency.

Furthermore, the transmission elements 170 incorporated into the PSA 130 as well as the elements incorporated into the first object 110 and/or second object 120 can respond to activation by electromagnetic energy. In particular, such elements can produce vibrations within the PSA 130 in response to electromagnetic field applied thereto. For example, such elements can comprise metallic particles that can be stimulated by the vibration device 140, which has alternating magnetic polarity, such as to induce vibration of the transmission elements 170. This vibration can be subsequently transmitted into the first object 110, second object 120, and/or PSA 130.

It should be noted that transmission elements can generate heat in the objects and/or PSA within which the elements vibrate. Such heat generation can be disadvantageous and can result in damage to one or more of the objects and/or to the PSA. Accordingly, in at least one implementation, the generated heat can be limited to a temperature increase of about 15°. For instance, the temperature increase generated by the vibrating elements can be in one or more of the following ranges: 1-5°, 2-10°, and 10-15°.

In light of this disclosure, those skilled in the art should appreciate that limiting the amount of temperature decrease can be achieved by limited the frequency and amplitude of the vibrations. For example, the frequency of the vibrating elements can be limited to about 200 Hz. In particular, the frequency of the vibrating elements can be in one or more of the following ranges: 1-100 Hz, 20-200 Hz, 100-1000 Hz, 500-5,000 Hz, and 5,000-10,000 Hz.

Furthermore, other contactless vibration device 140 can be used to deliver vibrational energy to the PSA coupled structure 100. For example, the vibration device 140 can generate alternative pressure waves, which can impact the first object 110, second object 120, and/or PSA 130. The alternating impacts can generate longitudinal vibrations within the PSA coupled structure 100, including at the interface of the first and second objects 110, 120 and PSA 130 as well as within the PSA 130.

FIGS. 1-13, the corresponding text, and the examples, provide a number of different system and mechanisms for reducing a coupling strength of the PSA 130 as well as for reducing required pull force for decoupling the first object 110 and second object 120. In addition to the foregoing, implementations of the present invention can also be described in terms of flowcharts comprising acts and steps in a method for accomplishing a particular result. For example, FIG. 14 illustrates a flowchart of one exemplary method for reducing coupling strength of the PSA. The acts of FIG. 14 are described below with reference to the components and diagrams of FIGS. 1 through 13.

For example, FIG. 14 shows the method can include an act 200 of reducing a coupling strength of a PSA 130 by applying vibrational energy. For example, act 200 can involve decreasing a coupling strength of the PSA by applying an amount of vibrational energy to one or more of a first object, a second object, and the PSA. In such implementations, the first object can be coupled to the second object by the PSA. A first force can be required to move the first object relative to the second object or to decouple the first object from the second object.

In one or more implementations, act 200 can further involve applying vibrational energy having a frequency in the range of 1 to 100,000 Hz. More specifically, act 200 can involve applying vibrational energy with a frequency in the range of 1 to 20,000 Hz or in the range of 100 to 1000 Hz. Act 200 can involve applying the vibrational energy using a vibration device. More specifically, act 200 can involve abutting a tip or head of the vibration device proximate a peel interface 102 of the first and second objects 110, 120. Alternatively, act 200 can involve abutting a tip or head of the vibration device at an edge of the first object 110 and/or second object 120.

In one or more implementations, act 200 can involve causing elements 170 within the PSA 130 to vibrate. The vibration of the elements 170 can reduce the coupling strength of the PSA 130. In any event, the act 200 of applying vibrational energy can reduce the coupling strength of the PSA required to move the first object relative to the second object or to decouple the first object from the second object from the first force (e.g., pull force) to a second force (e.g., pull force). The second force being smaller than the first force. In at least one implementation, the vibrational energy can decrease the coupling strength of the PSA 130 by at least approximately 10-25%. Additionally or alternatively, the coupling strength can be decreased by at least approximately 25-50%, 50-75%, 75-85%, and 90%.

FIG. 14 further shows that method can include and act 210 of applying a reduced force to move an object coupled to the PSA. For example, act 210 can involve at least partially decoupling the first and second objects by applying the second force. Alternatively, act 210 can involve repositioning the first object relative to the second object by applying the second force. Act 210 can involve applying a pull force to the first object or the second object.

In one or more implementations, the first object 110 and/or second object 120 can be made from a flexible material. Alternatively, the first and/or second objects 110, 120 can be made from a rigid material. In some instances, the flexible material can be a sheet, strip, or a block. For example, the first and/or second objects 110, 120 can be bandages, medical tapes, foams, dressings, wraps, compression systems, scaffolds, sealing systems, skin closure systems, attachments, probes, guides, sensors, insulators, drug delivery devices, devices that can couple to animal tissue, or a combination thereof.

The first and second objects 110, 120 also can be made from organic or inorganic material. For instance, the first and/or second objects 110, 120 can be made from a predominantly a polymeric material, such as a synthetic polymeric material or natural polymeric material. Such materials can include cellulosic materials (e.g., wood, cardboard, paper, cotton, etc.) Additionally, the first and/or second objects 110, 120 can be living plant tissue or a living animal tissue, such as skin, bone, vessels, and other tissue. Other suitable materials also include metals, ceramics, minerals, semiconductor materials, composite materials, or various combinations thereof.

Moreover, the first object 110 and/or second object 120 can be device coupled to the animal tissue is an ostomy appliances, catheters, splints, sutures, infusion pumps, a semi-permanent intravenous needles, or various combinations thereof. In at least one implementation, the first and/or second objects 110, 120 can include one or more tabs secured proximate to an edge or extending from the edge thereof. Such tabs can be configured to remain uncoupled from or lightly coupled to the first or second objects 110, 120. The tabs can have at least one dimension in the range of 1-100 mm or in the range of 2-20 mm.

The first and/or second objects 110, 120 as well as the PSA 130 also can incorporate embedded elements. For instance the first and/or second objects 110, 120 can have embedded fibers that have an elongate shape. Such fibers can align along a width or a length of the first or second objects 110, 120. Alternatively, the 110, 120 can have embedded particles.

Repositioning of the first object 110 with respect to the second object 120 can be sliding, moving, rotating, lifting, decoupling (at least in part), or a combination thereof. For example, the first and second objects 110, 120 can be at least in part separated one from another. Alternatively, the first and/or second objects 110, 120 can rotate (e.g., by sliding) or move laterally with respect to each other. Furthermore, the second force can be applied substantially in a direction perpendicular to this interface between the first object 110 and second object 120.

In some instances, the vibrational energy can decrease the coupling strength of the PSA 130 to the first object 110 and/or second object 120. Additionally or alternatively, the vibrational energy also can reduce structural integrity of the PSA 130. Accordingly, the PSA 130 can remain on the first object 110 or second object 120 during or after repositioning or can partially remain on both the first and second objects 110, 120.

In light of this disclosure, it should be appreciated by those skilled in the art that the first object 110 and/or second object 120 can comprise various material and can form PSA-coupled structures in various applications. Similarly, the PSA 130 can have various chemical compositions as well as coupling strengths. It should be noted that the methods and systems disclosed herein can facilitated decoupling of any solid objects. Additionally, designations of the first and second objects are arbitrary and have been made for illustrative purposes only. Accordingly, any material or device described herein can be either the first object 110 or second object 120 in the PSA-coupled structure 100.

The following are examples of various materials that can be used in PSA-coupled structures 100 as well as various applications in which the method and system described herein can be used. Furthermore, the test data described below, which was obtained during various experiments, is exemplar and is provided only to further illuminate various aspect of the invention. As such, the examples and test data shall be construed as exemplar only and not as limiting the scope of the invention in any way.

Although all of the possible applications and permutations are impossible to list, examples of the first object 110 and/or second object 120 (depending on application) include but are not limited to paper labels, film labels, packaging tapes, office tapes, home tapes, masking tapes, electrical tapes, baby diaper tapes, medical tapes, foam sealing tapes, duct tape, adhesive bandages, first aid tapes, surgical tapes, transdermal patches, nameplates, advertising signs, traffic signs, vehicle signs, automotive labels, automotive adhesives, postage stamps, envelopes, note pads, floor tiles, window films, protective films, decorative films, abrasive disks, membrane switches, and medical devices that can couple or attach to a patient's skin. Examples of such medical devices can include but are not limited to ostomy appliances, catheters, splints, sutures, infusion pumps, a semi-permanent intravenous needle, or a combination thereof. It should be noted that some of the above-described applications and uses relate to examples of only first object 110 or second object 120. Accordingly, in light of this disclosure, those skilled in the art should appreciate that the PSA-coupled structure 100 that is formed by the exemplar first object 110 or second object 120, described above, by implication include examples of the second object 120 and first object 110, respectively, which would couple to the above-described objects (e.g., example of adhesive bandages as one object includes patient's skin as the other object in the PSA-coupled structure 100). Additionally, the PSA can be used in various new applications, which require removable coupling and a coupling strength that would damage or break the coupled objects during decoupling.

In addition to the materials ordinarily used for the applications described above, other materials also can be used in the PSA-coupled structure 100. For example, the first object 110 and/or second object 120 can comprise of any solid organic or inorganic material. Examples of suitable organic materials include polymers, cellulosic materials (e.g., wood, cardboard, paper, etc.), plant and animal tissue, and various combinations thereof. Animal tissue can include mammalian tissue, human tissue, and other animal tissue. Additionally, animal tissue also includes skin, bone, vessels, and other tissue. Some of the examples of the suitable inorganic materials include synthetic polymers, metals, ceramics, minerals, semiconductor materials, composites, and various combinations thereof.

Additionally, examples of suitable materials for the first object 110 and second object 120 include naturally occurring polymeric materials such as cellulosic and proteinaceous polymeric materials. Cellulosic materials include wood, paper, cardboard, cotton, and other similar materials. Proteinaceous polymeric materials include silk and other similar materials. Plant and animal tissues include tissue of both living organisms and dead (e.g., leather). Animal tissues include skin, bone, vessels, neuronal tissue, and other animal tissues.

### Examples and Test Data

This systems and methods for reducing bonding or coupling strength of pressure-sensitive adhesives have been tested in several independent testing laboratories. In each case, an MTS-2/G instrument (MTS System Corporation, Eden Prairie, Minn.) was used with an Instron 2820-036 sliding sled (Instron, Inc., 825 University Avenue, Norwood, Mass.) in a standard 90° peel test (ASTM D6862-04 Standard Test Method for 90° peel resistance of adhesives). Various medical tapes and dressings as well as industrial tapes were decoupled from a number of substrates including vitro-skin and stainless steel. In each case, a Philips Sonicare e-Series toothbrush was used to deliver vibrational energy to the back of the tape in the vicinity of the peel interface. The bristles on the toothbrush were trimmed to provide a substantially flat interface with a vertical section of the tape proximate to the peel interface. In all of the experiments, the vibrational energy was delivered through the back side of the tape. The crosshead speed was 25 millimeters/minute. The vibrational frequency of the Sonicare toothbrush was 262.5 Hz, with a vibrational amplitude of approximately 0.93 millimeters at the tip of the bristles. (“The Effects of Load and Toothpaste on Powered Toothbrush Vibrations,” S. C. Lea et al., Journal of Dentistry, Vol 35, 2007, pp. 350-354.) The bristles and subsequent vibrations were applied to the vertical section of the peeled tape proximate to the peel interface with a load force of 1 N. The tapes and bandages were all pressed and attached to the various substrates with a uniform load of 3.5 pounds per square inch for 1 minute.

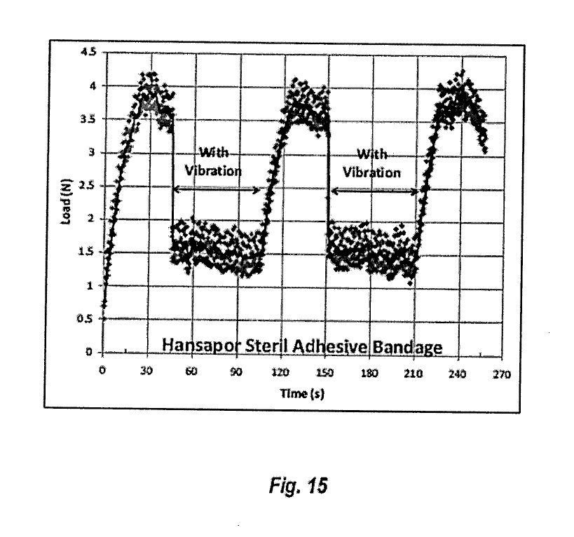

The first series of tests were conducted with 3M medical tapes. The pull force for the 3M tape was measured first without any vibrational energy being delivered to the PSA-coupled structure. A pull force for a second identical 3M tape was then measured with the vibrational energy being delivered. The resulting reductions in average required pull force were measured as follows: 3M Durapore 50% reduction; 3M Micropore 67% reduction; and 3M Transpore 80% reduction. FIG. 15 illustrates the pull force reduction for the 3M Transpore tape, while the vibrational energy was delivered thereto.

A second series of tests were conducted with Smith & Nephew medical tapes, bandages and dressings. In these tests, the peel test was initiated without vibration for 45 seconds and then the vibration was initiated and applied for 60 seconds. The resulting reductions in average pull force were measured as follows: Opsite Flexifix 52%; Opsite Flexigrid 38%; Hansapor Steril 56%; Opsite Post-Op 88%; Allevyn Adhesive 41%; and Allevyn Gentle Border 38%.

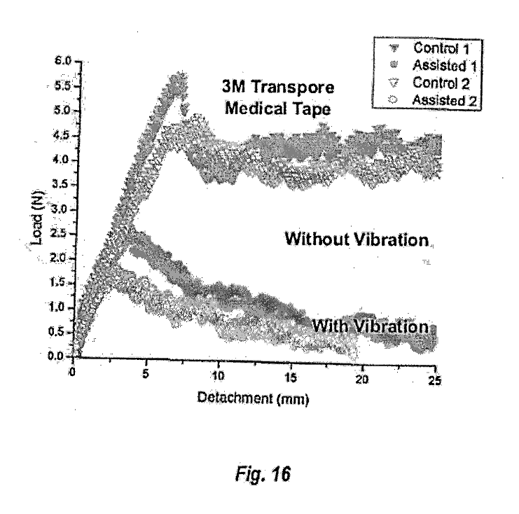

Opsite Flexifix is a flexible transparent film roll with an acrylic adhesive. Opsite Flexigrid is a transparent film dressing with an acrylic adhesive. The Hansapor Steril dressing is made from a non-woven fabric that is porously coated with a polyacrylate adhesive. The pull force for the Hansapor Steril adhesive bandage tape was reduced by over 90% in a similar experiment when the vibrating brush was applied at 45 degrees into the apex of the radius of curvature at the peel interface. FIG. 16 illustrates the reduction in pull force for Smith & Nephew's Hansapor Steril adhesive bandage both with and without vibrational energy.

The Opsite Post-Op is a waterproof dressing with a unique grid pattern adhesive. Allevyn Adhesive is a hydrocellular adhesive foam dressing with a polyurethane outer layer and a hypoallergenic adhesive. The Allevyn Gentle Border is a triple-layered hydrocellular foam dressing with a silicone gel adhesive and the vibrational energy was delivered through the triple layer of backing, foam and PSA. In additional tests, 3M Transpore tape was removed from stainless steel with about a 50% reduction in pull force. Commercial duct tape was also removed from vitro skin with about a 90% reduction in pull force.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1-104. (canceled)

105. A method of decoupling a first object from a second object, the first object being coupled to the second object by a pressure-sensitive adhesive (PSA) and requiring a first force to be decoupled, the method comprising:
decreasing a coupling strength of the PSA by delivering an amount of vibrational energy to one or more of the first object, the second object and the PSA,
wherein:
the coupling strength of the PSA is reduced to require a second force to decouple the first and second objects, and
the second force is less than the first force; and
at least partially decoupling the first and second objects by applying the second force.

106. The method as recited in claim 105, further comprising delivering the vibrational energy proximate to or at an edge of one or more of the first and second objects or at a peel interface of the first object or the second object and the PSA.

107. The method as recited in claim 105, wherein at least partially decoupling comprises moving the first object or the second object in a first direction which may be substantially perpendicular to an interface between the first object or the second object and the PSA.

108. The method as recited in claim 105, wherein one or more of the first and second objects comprise a flexible material such as a sheet, strip, block, or combination thereof.

109. The method as recited in claim 105, wherein one or more of the first and second objects comprise a rigid material such as animal or mammalian skin, bone or other tissue.

110. The method as recited in claim 109, wherein the first object is selected from the group consisting of bandages, medical tapes, foams, dressings, wraps, compression systems, scaffolds, sealing systems, skin closure systems, attachments, probes, guides, sensors, insulators, drug delivery devices, devices that can couple to animal tissue, or a combination thereof.

111. The method as recited in claim 110, wherein the device coupled to the animal or mammalian tissue is an ostomy appliance, catheters, splints, sutures, infusion pumps, a semi-permanent intravenous needle, or a combination thereof.

112. The method as recited in claim 105, wherein one or more of the first and second objects have one or more tabs secured proximate to an edge or extending from the edge thereof.

113. The method as recited in claim 112, wherein the one or more tabs have at least one dimension in the range of 1 mm to 100 mm.

114. The method as recited in claim 105, wherein the one or more of the first and second objects contain embedded elements comprising fibers, particles, rods or lamellae.

115. The method as recited in claim 105, wherein delivering the vibrational energy comprises contacting at least one of the first object, the second object and the PSA with a vibration device.

116. The method as recited in claim 115, wherein the vibration device delivers the vibrational energy at a frequency in the range of 1 to 100,000 Hz.

117. The method as recited in claim 115, wherein the vibration device comprises a removable vibrating head.

118. A pressure-sensitive adhesive structure, comprising:
a first object having a first side and a second side;
a pressure-sensitive adhesive coupled to the first side of the first object and configured to be coupled to a second object; and
a plurality of embedded elements located within the pressure-sensitive adhesive, the plurality of embedded elements comprising at least one of fibers, particles, rods and lamellae for transfer of vibrational energy to an interface between the pressure-sensitive adhesive and the second object.

119. A bonding strip configured to be coupled to an object, the bonding strip comprising:
a sheet material;
a pressure-sensitive adhesive disposed on a first side of the sheet material and adapted to couple to the object; and
one or more tabs secured proximate to an edge or extending from the edge of the sheet material,
wherein the one or more tabs are configured to remain uncoupled from the object and to transfer vibrational energy through the sheet material to the pressure-sensitive adhesive for reducing a coupling strength of the pressure-sensitive adhesive and the object.

120. The bonding strip as recited in claim 119, wherein the one or more tabs extend from the edge of the sheet material between 1 mm and 100 mm.

121. The bonding strip as recited in claim 119, wherein the sheet material is integrated into or forms a part of a bandage, medical tape, sensor lead, transdermal drug delivery device, devices that can couple to animal or mammalian tissue such as an ostomy appliance, catheter, splint, suture, infusion pump, a semi-permanent intravenous needle, or a combination thereof.

122. The bonding strip as recited in claim 119, wherein the pressure-sensitive adhesive contains a plurality of embedded elements sele cted from the group consisting of fibers, rods, particles and lamella.

123. A vibration device for delivering vibrational energy to a PSA-coupled structure, the vibration device comprising:
a body containing a vibratory mechanism; and
a tip coupled to the body such that the vibratory mechanism produces vibrations in the tip in the range of 20 Hz to 20,000 Hz;
wherein the tip has a substantially round or elongated shape with bristles or ribs extending from a central region of the tip and is configured to deliver the vibrations to the PSA-coupled structure for reducing a coupling strength of the PSA-coupled structure.
